(19) United States
(12) Patent Application Publication
(10) Pub. No.: US 2005/0169191 A1
(43) Pub. Date: Aug. 4, 2005

(54) Accounting system and method based on network service quality in a mobile communication system

(75) Inventors: Dong-Jo Cheong, Yongin-si (KR); In-Dong Yeo, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/045,330

(22) Filed: Jan. 31, 2005

(30) Foreign Application Priority Data
Jan. 31, 2004 (KR) 2004-6481

(51) Int. Cl. H04L 12/26

(52) U.S. Cl. 370/252

(57) ABSTRACT

Disclosed is an accounting system and method based on network service quality in a mobile communication system. The system and method for controlling accounting according to quality of service (QoS) information of a packet data service system, comprises allocating by a packet data service node QoS based on QoS profiles transmitted from an authentication, authorization, and accounting (AAA) server and setting by the packet data service node a service instance which is able to differentiate applications according to QoS levels, the packet data service node having received the QoS information requested to be set from a mobile station, and after service is started, adding by the packet data service node the allocated QoS information to accounting information including information regarding an amount of packet data transmitted to the mobile station so as to transmit the allocated QoS information to the AAA server.

### PRIORITY

This application claims the benefit under 35 U.S.C. 119(a) of application entitled “Accounting Method Based On Network Service Quality in Mobile Communication System” filed in the Korean Intellectual Property Office on Jan. 31, 2004 and assigned Serial No. 2004-6481, the contents of which are incorporated herein by reference.

### BACKGROUND OF THE INVENTION

1. Field of the Invention

The present invention relates to an accounting system and method of a mobile communication system. More particularly, the present invention relates to a system and method for performing accounting differentiated according to the quality of service.

2. Description of the Related Art

The Code Division Multiple Access 2000 (CDMA2000) system was developed from an IS-95 standard based on transmission/reception of voice signals and now conforms to IS-2000 and IS-856 standards for performing high speed data transmission as well as voice transmission. In particular, CDMA2000 1X and First Evolution-Data Only (1xEV-DO) systems provide a data delivery function using packets. However, as various additional services are provided through mobile communication, with the evolution of a network, it becomes inevitable to require quality of service (QoS) differentiated according to various users or various applications.

As a scheme for satisfying the above described requirement, the concept of the QoS is introduced when packets are delivered. A conventional packet delivering scheme in a CDMA 2000 packet network delivers packets through a best effort scheme. However, since video telephony service and VoIP service employing a future packet delivering scheme must be processed in real time, the video telephony service and the VoIP service must have quality ensured differently from that of services such as conventional E-mail service and conventional File Transfer Protocol (FTP) service, and proper accounting must be performed differently. In particular, Voice over IP Gateway (VoIP), Video on Demand (VOD), Audio on Demand (AoD), multimedia message service (MMS), and Push to Talk (PTT) may be types of services requiring differentiated quality of service described above.

In order to provide the differentiated service, accounting policies must also be differentiated according to different types of applications. A 3^{rd} Generation Partnership Project 2 (3GPP2) X.SOO11-C (ballot) standard under the recent standardization work requires that service differentiated according to applications must be provided when multiple service instance (MSI) is supported in a terminal.

In other words, when MSI is supported in the terminal as described above, since end-to-end QoS must be ensured, it is necessary to differentiate accounting policies to match with the end-to-end QoS. However, accounting information (Usage Data Record: UDR) of the recent 3GPP2 X.S0011-C (ballot) standard does not include specific information except for a service reference identifier which is changes according to the applications used.

The following Table 1 includes QoS parameters of accounting information transmitted to an authentication, authorization and accounting (AAA) server from a packet data service node using a conventional technique.

TABLE 1

| | | Radius Attribute Definitions | | | | |
|---|---|---|---|---|---|---|
| | | | Maximum | | | |
| | | Type/ | Payload | | | |
| | | Vendor | Length | | | |
| Item | Parameter | type | (In Octets) | Format | Field | Special Value |
| 11 | IP Quality | 26/36 | 4 | Integer | 3GPP2_IP_QOS | This attribute is deprecated |
| | of Service | | | | | |
| 14 | Airlink | 26/39 | 4 | Integer | 3GPP2_Air_Priority | Least significant 4 bits hold |
| | Priority | | | | | the priority associated with |
| | | | | | | the packet data service |

Referring to Table 1, information corresponding to the QoS parameters, which are collected and created by the packet data service node, is included in a field “RADIUS Attribute Definition”. Table 1 includes a parameter “I1” of “IP Quality of Service” (QoS information processible on an IP node) and a parameter “Airlink Priority” (priority information about a wireless link). In other words, the parameter 11 has a structure including a DiffServ code value. Herein, a DiffServ scheme is one of IP QoS providing schemes defined in a network layer when the DiffServ scheme is considered in view of a CDMA 2000 network. The IP QoS providing schemes can be processed at an IP node. In the case of the CDMA 2000 network, the IP QoS providing schemes may be applied to a terminal, a packet data service node, and plural routers included in an IP core network. Although accounting for a core network can be achieved only with a DiffServ code as described above, proper accounting for QoS of a wireless interval cannot be provided.

However, Access Network quality of service (AN QoS) information, which has been substantially allocated to applications, is not included in Table. 1.

Accordingly, it is difficult for vendors to perform accounting differentiated according to the type of application used based on accounting information such as usage data record (UDR).

### SUMMARY OF THE INVENTION

Accordingly, the present invention has been made to solve the above-mentioned problems occurring in the prior art, and it is an object of the present invention to provide a system and method for performing accounting differentiated according to applications requiring differentiated quality of service (QoS).

To accomplish the above object, there is provided a method for controlling accounting according to quality of service (QoS) information of a packet data service system. The system and method comprise allocating by a packet data service node a quality of service (QoS) based on QoS profiles transmitted from an authentication, authorization, and accounting (AAA) server and setting by the packet data service node a service instance which is able to differentiate applications according to quality of service (QoS) levels, the packet data service node having received quality of service (QoS) information requested to be set from a mobile station, and after service is started, adding by the packet data service node the allocated quality of service (QoS) information to accounting information including information regarding an amount of packet data transmitted to the mobile station so as to transmit the allocated quality of service (QoS) information to the authentication, authorization and accounting server.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a mobile communication system for accounting according to a quality of service according to an embodiment of the present invention;

FIG. 2 is a table illustrating a structure of an accounting information message transmitted between a packet control function (PCF) and a packet data service node (PDSN);

FIG. 3 is a table illustrating a structure of an accounting information message transmitted to an authentication, authorization, and accounting (AAA) server from a PDSN according to one embodiment of the present invention;

FIG. 4 is a detailed table illustrating a structure of a quality of service parameter requested from an access network (AN);

FIG. 5 is a detailed table illustrating a structure of a quality of service parameter substantially used in an AN; and

FIG. 6 is a detailed table illustrating a structure of a data drop count parameter representing an amount of dropped packets.

### DETAILED DESCRIPTION OF THE PREFERRED EMBODIMENT

Hereinafter, an embodiment of the present invention will be described in detail with reference to the accompanying drawings. The same or similar components in the drawings are designated by the same reference numerals throughout the drawings. In the following description of the embodiment of the present invention, a detailed description of known functions and configurations incorporated herein will be omitted for conciseness.

The embodiment of the present invention provides a technique for making up new parameters by adding QoS (quality of service) information differentiated according to the types of applications from a terminal to accounting information transmitted to an Authentication, Authorization and Accounting (AAA) server from a packet data service node.

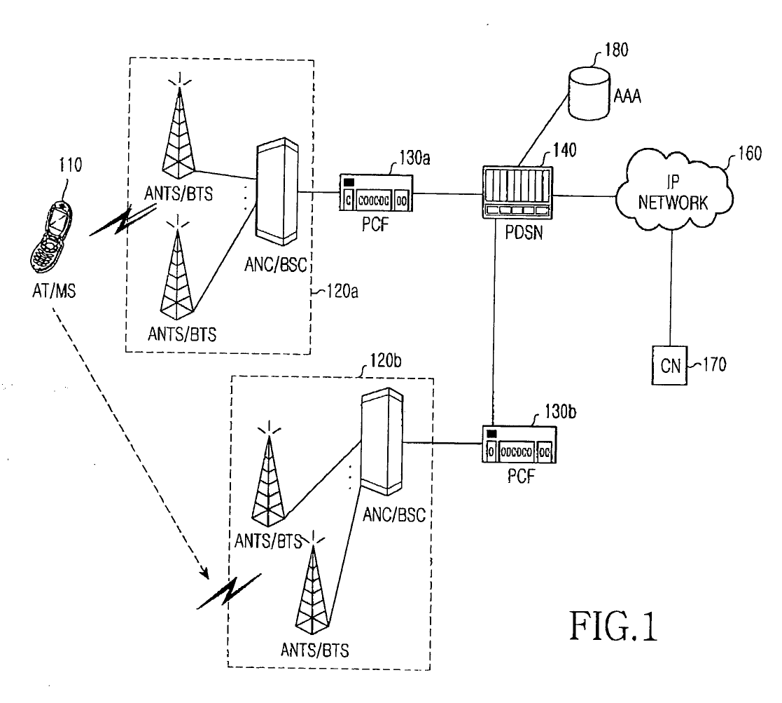

Hereinafter, a mobile communication system for realizing the embodiment of the present invention will be described with reference to FIG. 1. Herein, although an embodiment, is applied to a Code Division Multiple Access 2000 (CDMA 2000) First Evolution-Data Only (1x EV-DO) system, the embodiment is not limited to the CDMA 2000 1x EV-DO system and can be applied to other types of systems providing QoS differentiated according to the types of applications.

Referring to FIG. 1, the mobile communication system includes an access terminal/mobile station (AT/MS) 110, an access network transceiver system/base station transceiver system (ANTS/BTS) for making wireless communication with the AT/MS 110, an access network controller/base station controller (ANC/BSC) 120a and 120b for controlling the ANTS/BTS, a packet data service node (PDSDN) 140, packet control functions (PCFs) 130a and 130b connected between the PDSN 140 and the ANC/BSCs 120a and 120b and establishing packet data communication with them, an authentication, authorization and accounting (AAA) server 180 for performing accounting and service authentication, and a correspondent node (CN) 170 for showing the range of providing end-to-end QoS together with the AT/MS 110. The PDSN 140 and CN 170 are connected to an IP network 160. It should be appreciated by those skilled in the art that the elements of FIG. 1 can also comprise modules. Thus, the modules can be separate or integrated into various elements of the system of FIG. 1. For example, a PSDN module can be located in the PSDN 140 or can be integrated into the AAA server.

The AT/MS 110 performs a CDMA 2000 wireless connection to an Access network (AN) and is linked with the PSDN 140 through Point to Point Protocol (PPP) link layer connection. The AT/MS 110 supports multiple service instance (MSI) and provides a QoS function by establishing wireless traffic suitable for a characteristic of an application through the MSI. To this end, the AT/MS 110 is positioned at a network end in order to provide end-to-end QoS and processes an end-to-end QoS signal. In addition, the AT/MS 110 maps requirements for QoS of applications with IP QoS parameters and transmits the mapped QoS information to the CN 170 through the Resource Reservation Protocol (RSVP). However, the transmission of the mapped QoS may be achieved through another signaling method if the MSI is employed in a core network in the future. Herein, the PDSN 140 establishes a QoS bearer channel based on the QoS information within the interval of a CDMA 2000 AN 120.

The AN 120 provides the CDMA 2000 wireless connection function together with the AT/MS 110, and provides packet data service through a reverse path (R-P) connection together with the PDSN 140. In addition, according to the embodiment of the present invention, the AN 120 counts the amount of data that are dropped without being transmitted to the AT/MS in a packet data service and transmits the dropped amount to the PDSN 140 such that the dropped amount may be used as accounting information. In addition, the access network (AN) 120 determines allocable QoS information according to a request from a user for QoS desired by the user and transmits the determined QoS information to the PDSN 140.

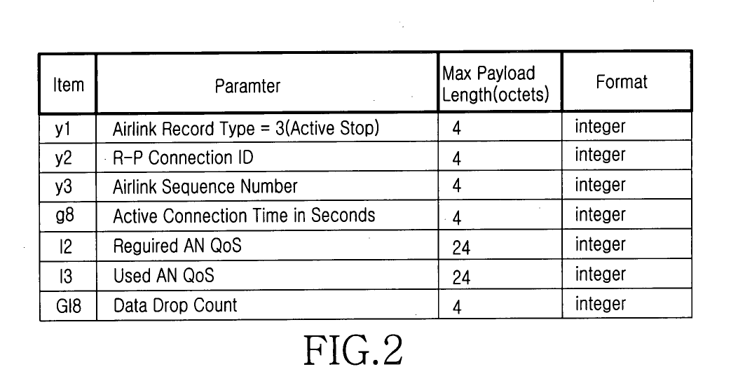

FIG. 2 is a table illustrating a structure of an accounting message transmitted to the PDSN from the PCF, and the accounting message includes the amount of dropped data, a QoS parameter requested from the user, and a QoS parameter allocable to the user.

The PDSN 140 is connected with the AN 120 through the R-P connection and provides PPP connection to the AT/MS 110 through the R-P connection. In addition, the PDSN 140 provides packet data service to the AT/MS 110 through the PPP connection. The PDSN 140 acquires QoS profiles according to subscribers by connecting with the AAA server 180 and, when the AT/MS 110 requests QoS establishment, performs QoS authentication on the basis of the acquired QoS profiles.

The PDSN 140 supports “RSVP protocol” or “Localized RSVP protocol (IETF Internet Draft state)” in order to process QoS signals. The PDSN 140 may receive QoS requirements from the AT/MS 110 in the form of the IP QoS parameter and map the QoS requirements with AN QoS parameters. However, this may be achieved through another signaling method if the concept of the MSI is introduced into the core network in the future as described above. In addition, the PDSN 140 can set the MSI according to the request of the AN 120.

The PDSN 140 detects time points at which the AT/MS 110 starts and ends the reception of data service, creates accounting data record obtained by aggregating accounting information, and transmits the accounting data record to the AAA server 180. Herein, the accounting data record (ADR) is registered in the PDSN 140 and provided, and includes the contents of the service for a terminated session.

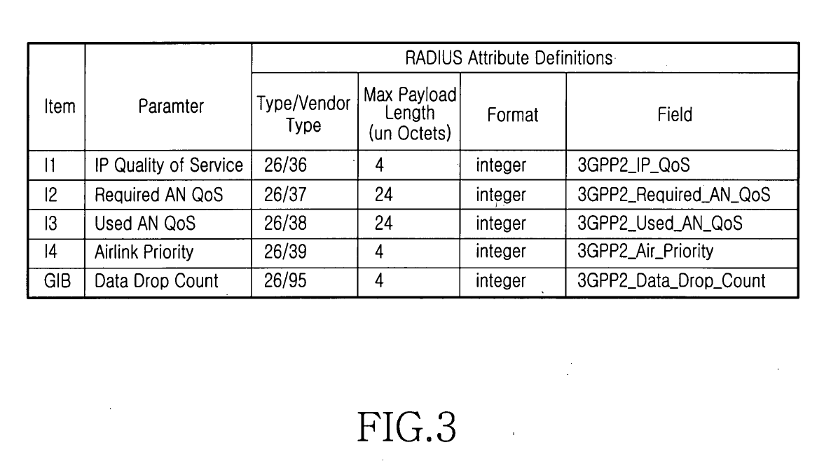

According to one embodiment of the present invention, the PDSN 140 adds new QoS parameters relating to accounting to the usage data record (UDR). FIG. 3 is a view illustrating a table obtained by adding two new parameters to the existing parameters, “Airlink Priority” and “IP Quality of Service”.

Referring to FIG. 3, the QoS parameters include a parameter “Required AN QoS”, a parameter “Used AN QoS”, and a parameter “Data Drop Count” which are also shown in Table 2.

The parameter “Required AN QoS” refers to QoS information requested by the PDSN 140 from the AN 120 when the above-described QoS bearer channel is established.

The parameter “Used AN QoS” refers to information about QoS substantially allocated on the basis of the QoS profiles according to subscribers acquired through connection with the AAA server 180 after the requested QoS information is received.

The parameter “Data Drop Count” is used for defining an amount of dropped packets transmitted from the AN 120 as described above. This parameter is used such that the PDSN 140 performs more precise accounting by subtracting charges corresponding to the amount of the dropped packets from a packet data service fee transmitted to the AT/MS 110 when the AT/MS 110 does not employ the flat-rate plan with respect to reception of charged service.

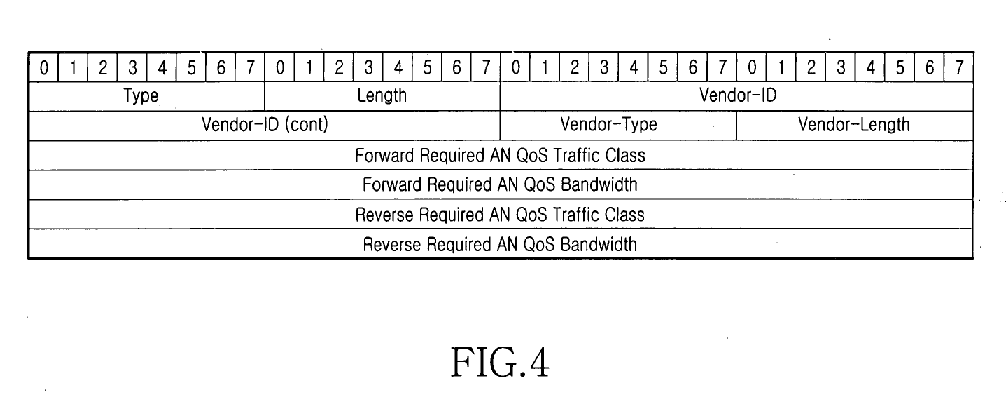

FIGS. 4 to 6 are detailed tables illustrating tables for the parameters added as described above.

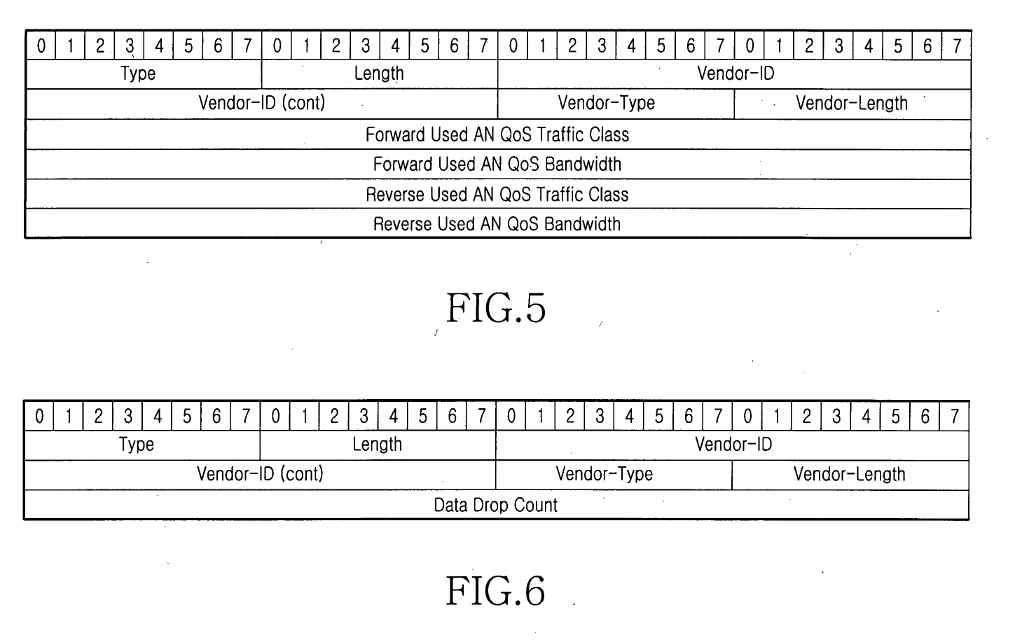

FIG. 4 is a table illustrating the structure for the parameter “Required AN QoS”, FIG. 5 is a table illustrating the structure for the parameter “Used AN QoS”, and FIG. 6 is a table illustrating the structure for the parameter “Data Drop Count” representing an amount of dropped data.

Referring FIGS. 4 and 5, QoS traffic class fields and QoS bandwidth fields exist, QoS mapping is achieved according to the types of applications as described above, and classes and bandwidths must be determined suitably for applications having their own characteristics.

Hereinafter, an operation for an accounting method according to the QoS in the above described mobile telecommunication system will be described in accordance with the embodiment of the present invention. The description of the operation includes description about a service instance setting procedure for providing QoS differentiated according to various applications and a description about an accounting procedure using QoS information determined in the service instance setting procedure.

First, the description about the service instance setting procedure differentiated according to applications will be given.

In order to provide end-to-end QoS, QoS to be substantially provided on an IP layer is reserved by using QoS signaling, such as signaling for a resource reservation protocol (RSVP) path and an RSVP reservation message, between the AT/MS 110 and the correspondent node 170. This signaling may be achieved through another scheme when the concept of the MSI is introduced into the core network in the future.

After that, the PDSN 140 can perform AN QoS mapping by using RSVP flow description. In a 3GPP2 standard under a current standardization work, traffic classes may be classified into four types.

In other words, the traffic classes may be classified into a conversation class (such as VoIP, Video Telephony, and Interactive games), a streaming class (such as Streaming. Service, FTP, and Still Images), an interactive class (such as Voice Messaging, Web browsing, E-commerce), and a background class (such as E-mail). In addition, these traffic classes may be further classified into seven AN traffic classes in the AN 120.

The PDSN 140 confirms guaranteed/controlled load service, performs a port mapping, and allocates a bandwidth by using an RSVP Resv message format. At this time, the PDSN 140 can restrict the bandwidth on the basis of QoS profiles transmitted from the AAA server 180 with respect to service requiring an excessive bandwidth.

The AN 120 receiving such information receives QoS information through an A11 session update message and performs QoS authorization and admission control as defined in the 3GPP2 IOS 4.3, which is incorporated herein by reference. When the QoS authorization and the admission control are normally performed, the AN 120 delivers an acknowledgement (ACK) signal for the A11 session update message to the PDSN 140, and then, normal R-P connection is established. In other words, a new service instance is set.

Next, if a new service instance which can be differently provided according to QoS is set according to the procedure described above, the PDSN 140 performs an accounting procedure defined in the 3GPP2 X.S0011-C (ballot), which is incorporated herein by reference.

A time point at which accounting information is transmitted is referred to in the 3GPP2 X.S0011-C(ballot) standard. When the new service instance is created, since different levels of QoS is provided, accounting information of each service instance for the AN 120 must be transmitted to the AAA server 180. The PDSN 140 adds the requested AN QoS information (traffic class and bandwidth) and the substantially-allocated AN QoS information to QoS information included in accounting information (UDR) to be transmitted to the AAA server 180 by adding three new parameters according to the embodiment of the present invention to two existing parameter as shown in FIG. 3. Therefore, vendors may perform differentiated accounting.

In other words, the access network 120 counts an amount of data dropped without being transmitted to the AT/MS 110 in packet data service, determines allocable QoS information according to a request from a user for QoS desired by the user and transmits the determined QoS information to the PDSN 140.

The PDSN 140 recognizes time points at which the AT/MS 110 starts and ends the reception of data service, creates accounting data record obtained by aggregating accounting information, and transmits the accounting data record to the AAA server 180. Herein, the accounting data record (UDR) includes a parameter “Required AN QoS”, which is a QoS parameter transmitted from the access network, a parameter “Used AN QoS”, and a parameter “Data Drop Count”.

Thus, the AAA server 180 performs accounting according to information about the parameter “Used AN QoS”, and the PDSN 140 subtracts charges corresponding to the amount of the dropped packets from a packet data service fee transmitted to the AT/MS 110 when the AT/MS 110 does not employ the flat-rate plan with respect to reception of charged service.

As described above, according to the embodiment of the present invention, if accounting reflecting AN QoS information described above is introduced, it is possible to perform accounting more accurately than a simple accounting scheme based on an amount of used packets provided in a current mobile communication network, it is possible to perform accounting differentiated according to service and users, and detailed information can be detected. In addition, mobile communication vendors can perform accounting differentiated according to applications substantially used by mobile communication subscribers.

While the invention has been shown and described with reference to a certain embodiment thereof, it should be understood by those skilled in the art that various changes in form and details may be made therein without departing from the spirit and scope of the invention. Consequently, the scope of the invention should not be limited to the embodiment described, but should be defined by the appended claims and equivalents thereof.

1. In a communication system including a packet data service node for providing packet data service to a mobile station via an access network and an authentication, authorization, and accounting (AAA) server for accounting according to quality of service (QoS), the packet data service node comprising:
a means for transmitting packet data based on quality of service (QoS) to the access network;
a means for receiving information related to an amount of dropped packet data from the access network; and
a means for transmitting accounting information including information related to an amount of the transmitted packet data and the information related to the amount of the dropped packet data to the authentication, authorization, and accounting (AAA) server.

2. The packet data service node as claimed in claim 1, wherein the quality of service (QoS) is determined based on quality of service (QoS) requested by the mobile station and a quality of service profile of a subscriber related to the mobile station transmitted from the authentication, authorization, and accounting (AAA) server.

3. The packet data service node as claimed in claim 2, wherein the quality of service (QoS) is determined according to each application when a multiple service instance is supported.

4. A method for accounting according to quality of service (QoS) in a communication system including a packet data service node for providing packet data service to a mobile station via an access network and an authentication, authorization, and accounting (AAA) server for accounting, the method comprising the steps of:
transmitting packet data based on quality of service (QoS) to the access network;
receiving information related to an amount of dropped packet data from the access network; and
transmitting accounting information including information related to an amount of the transmitted packet data and the information related to the amount of the dropped packet data to the authentication, authorization, and accounting (AAA) server.

5. The method as claimed in claim 4, wherein the quality of service (QoS) is determined based on quality of service (QoS) requested by the mobile station and a quality of service (QoS) profile of subscriber related to the mobile station transmitted from the authentication, authorization, and accounting (AAA) server.

6. The method as claimed in claim 5, wherein the quality of service (QoS) is determined according to each application when a multiple service instance is supported.

7. In a communication system including a packet data service node for providing packet data service to a mobile station via an access network and an authentication, authorization, and accounting (AAA) server for accounting according to quality of service (QoS), the access network comprising:
a means for transmitting packet data based on service quality to the mobile station;
a means for calculating an amount of dropped packet data from the transmitted packet data; and
a means for transmitting information related to the amount of the dropped packet data to the packet data service node.

8. A method for accounting according to quality of service (QoS) in a communication system including a packet data service node for providing packet data service to a mobile station via an access network and an authentication, authorization, and accounting (AAA) server for accounting, the method comprising the steps of:
transmitting packet data based on quality of service (QoS) to the mobile station;
calculating an amount of dropped packet data from the transmitted packet data; and
transmitting accounting information related to the amount of the dropped packet data to the packet data service node.

9. In a communication system including a packet data service node for providing packet data service to a mobile station via an access network and an authentication, authorization, and accounting (AAA) server for accounting according to quality of service (QoS), the authentication, authorization, and accounting (AAA) server apparatus comprising:
a means for receiving accounting information including information related to an amount of dropped packet data and information related to an amount of packet data transmitted from the packet data service node; and
a means for accounting using the information related to the amount of the dropped packet data and the information related to the amount of the transmitted packet data.

10. The authentication, authorization, and accounting (AAA) server in claim 9, wherein the accounting means calculate a charge by subtracting the amount of the dropped packet data from the amount of the transmitted packet data.

11. A method for accounting according to quality of service (QoS) in a communication system including a packet data service node for providing packet data service to a mobile station via an access network and an authentication, authorization, and accounting (AAA) server for accounting, the method comprising the steps of:
receiving accounting information including information related to an amount of dropped packet data and information related to an amount of packet data transmitted from the packet data service node; and
accounting using the information related to the amount of the dropped packet data and the information related to the amount of the transmitted packet data.

12. The method claimed in claim 10, wherein the accounting is calculated by subtracting the amount of the dropped packet data from the amount of the transmitted packet data.

13. A system for tracking and accounting for packets in realtime according to quality of service (QoS) information of a packet data service system, comprising:
a mobile station module adapted to request the setting of quality of service (QoS) information; and
a packet data service node module adapted to receive the request from the mobile station module, allocate quality of service (QoS) based on QoS profiles transmitted from an authentication, authorization, and accounting (AAA) server module and set a service instance which is able to differentiate applications according to QoS levels, and after service is initiated, allocate the QoS information to accounting information comprising information regarding an amount of packet data transmitted to the mobile station module in order to transmit the allocated quality of service (QoS) information to the AAA server module.

14. The system method as claimed in claim 13, wherein the packet data service node module information receives information regarding the amount of dropped packet data among packet data transmitted from a base station.

15. The system method as claimed in claim 14, wherein the dropped packet data comprises accounting information.

16. The system as claimed in claim 13, wherein, the packet data service node module adds the QoS information requested from the mobile station and the QoS information set by the packet data service node to the accounting information.

17. The system as claimed in claim 13, wherein the packet data service node module is located in a packet data service node.

18. The system as claimed in claim 13, wherein the mobile station module is located in a wireless terminal.

19. The system as claimed in claim 13, wherein the packet data service module and the mobile station module are linked via a Point to Point Protocol (PPP) link layer connection.
